(19) United States
(12) Patent Application Publication
(10) Pub. No.: US 2003/0202796 A1
(43) Pub. Date: Oct. 30, 2003

(54) Optical wireless communication device and postion adjustment method therefor

(75) Inventors: Takumi Nagai, Tokyo (JP); Shintaro Yokota, Yokohama (JP); Yuichiro Gannen, Yokohama (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: Allied Telesis K.K., Tokyo (JP); YTECH DESIGN CO., LTD., Yokohama (JP)

(21) Appl. No.: 10/260,413

(22) Filed: Oct. 1, 2002

(30) Foreign Application Priority Data
Apr. 26, 2002 (WO) PCT/JP02/04235

(51) Int. Cl. H04B 10/00

(52) U.S. Cl. 398/151

(57) ABSTRACT

The optical wireless communication device 1 is provided with a transmitting unit 102 outputting a light such as a laser light for optical communication. Beside the transmitting unit 102, the optical wireless communication device 1 is also provided with a laser pointer 24 emitting a light for optical axis adjustment. Further, the front surface of the optical wireless communication device 1 has a sight 401 where a light for an optical axis adjustment irradiates to allow proper adjustment of an optical axis. The optical wireless communication device 1 allows optical axis adjustment to be quick and easy in the configuration where a position of a device of one side is adjusted for an optical axis alignment with the device of the other side by checking the lighting of the LED 22 in the other side.

### BACKGROUND OF THE INVENTION

1. Field of the Invention

The present invention relates to optical wireless communication device and its position adjustment method and, more particularly, to optical wireless communication device which can simplify and facilitate installation and adjustment of the optical wireless communication device.

2. Related Background Art

A number of techniques for computers to communicate with each other have been proposed and realized. The most widespread communication technique uses a coaxial cable or an optical cable. This communication technique has the advantage of higher speed communication. On the other hand, however, the communication technique using a cable has the problem that rearrangement of computers requires rewiring.

Recently, a communication technique using a radio wave has been widely applied. This communication technique has the advantage that rearrangement of computers does not require rewiring. The communication technique, however, has the problem of lower speed communication.

As a solution for the problems of the two communication techniques mentioned above, optical wireless communication using an optical beam that is transmitted through space is proposed. The optical wireless communication has the advantage that a communication path is easily hold, which is especially useful in communicating between buildings across a street from each other.

Here, it is necessary for an optical wireless communication device which performs optical wireless communication to be accurately arranged in order that a light emitted from a light emitting element of one side should be received by a light receiving element of the other side. However, since laser lights outputted from conventional optical wireless communication devices are not visual lights, it is difficult to determine where the lights strike. Therefore, it is hard to position an optical wireless communication device accurately to adjust an optical axis.

### SUMMARY OF THE INVENTION

The present invention has been accomplished to solve the above problems, and an object of the present invention is thus to provide an optical wireless communication device which facilitates adjustment of an optical axis, an optical wireless communication system, and a position adjustment method of the optical wireless communication device.

Optical wireless communication device according to the present invention is an optical wireless communication device which performs communication by lights having a transmitting unit outputting a light for optical communication, and an optical axis adjustment light emitting unit which is located at a position other than the transmitting unit, emitting a light for adjusting an optical axis to selectively irradiate a sight which is located beside a receiving unit receiving a light from the transmitting unit in the front of a optical wireless communication device of the other party.

Preferably, the optical axis adjustment light emitting unit is a laser pointer.

Also, the transmitting unit and the optical axis adjustment light emitting unit are preferably fixed relative to each other with a holder.

Further, it is preferable for the optical wireless communication device to have a telescope with which a direction almost parallel to an optical axis of the transmitting unit can be observed.

Furthermore, it is preferable that the optical wireless communication device has a telephoto camera with which a direction almost parallel to an optical axis of the transmitting unit can be observed and means of outputting image data taken by the telephoto camera.

In a preferred embodiment, the optical wireless communication device has a control unit controlling a position of the optical wireless communication device according to external control signals.

In an effective configuration, the optical wireless communication device has, in the above mentioned transmitting unit, a light reducing filter which is easily attached to or removed from the optical wireless communication device.

Further, the optical wireless communication device preferably has, in its front surface where a laser light is outputted from, a groove with which a filter holder having the light reducing filter is fitted.

Another optical wireless communication device according to the present invention is an optical wireless communication device which performs communication by lights having a transmitting unit outputting a light for optical communication, a receiving unit inputting a light for optical communication, and a removable filter which is attached to the above transmitting unit and/or the receiving unit.

Here, the optical wireless communication device preferably has, in its front surface where a laser light is outputted from, a groove with which a filter holder having the above mentioned filter is fitted.

The filter holder is preferably made of a flexible material.

Another optical wireless communication device according to the present invention is an optical wireless communication device which performs communication by lights having a transmitting unit outputting a light for optical communication, a receiving unit inputting a light for optical communication, and a display unit indicating reception in the receiving unit of a light from an optical wireless communication device of the other party, in the front surface where a light is outputted from the transmitting unit.

The display unit preferably is constituted of LED.

On the other hand, a position adjustment method of optical wireless communication device according to the present invention is a method of adjusting a position of a first optical wireless communication device and a second optical wireless communication device communicating with each other by lights having a step for outputting a light for optical axis adjustment from the first optical wireless communication device and a step for checking if the light outputted from the first optical wireless communication device falls on a sight on the second optical wireless communication device.

Another position adjustment method of optical wireless communication device according to the present invention is a method of adjusting a position of a first optical wireless communication device and a second optical wireless communication device communicating with each other by lights having a step for outputting a light for optical wireless communication from the first optical wireless communication device and a step for checking if the light outputted from the first optical wireless communication device is received by a receiving unit in the second optical wireless communication device by observing a display unit indicating reception of lights, which is mounted on the front of the second optical wireless communication device.

The present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a block diagram of a computer network containing an optical wireless communication device according to the present invention.

FIG. 2 is a block diagram of the optical wireless communication device according to the present invention.

FIG. 3 is a block diagram of a laser in the optical wireless communication device according to the present invention.

FIG. 4 is a diagram to show a light emission pattern of the laser and a light pattern after having passed through a diaphragm in the optical wireless communication device according to the present invention.

FIG. 5 is a diagram to illustrate lighting channel of a laser light outputted from the optical wireless communication device according to the present invention to be received by the optical wireless communication device of the other party.

FIG. 6 is a perspective view to show external appearance of the optical wireless communication device according to the present invention.

FIG. 7 is a diagram to show a state where a filter holder is attached to the optical wireless communication device according to the present invention.

FIG. 8 is a rear view of the optical wireless communication device according to the present invention.

FIG. 9 is a block diagram of a lens holder which is incorporated in the optical wireless communication device according to the present invention.

FIG. 10 is an explanatory diagram of a wavelength of a laser light outputted from the optical wireless communication device according to the present invention.

FIG. 11 is a front view of the optical wireless communication device according to the present invention.

FIG. 12 is a flowchart to show a position adjustment method of the optical wireless communication device according to the present invention.

FIG. 13 is a block diagram of another optical wireless communication device according to the present invention.

FIG. 14 is a perspective view to show external appearance of another optical wireless communication device according to the present invention.

### DESCRIPTION OF THE PREFERRED EMBODIMENTS

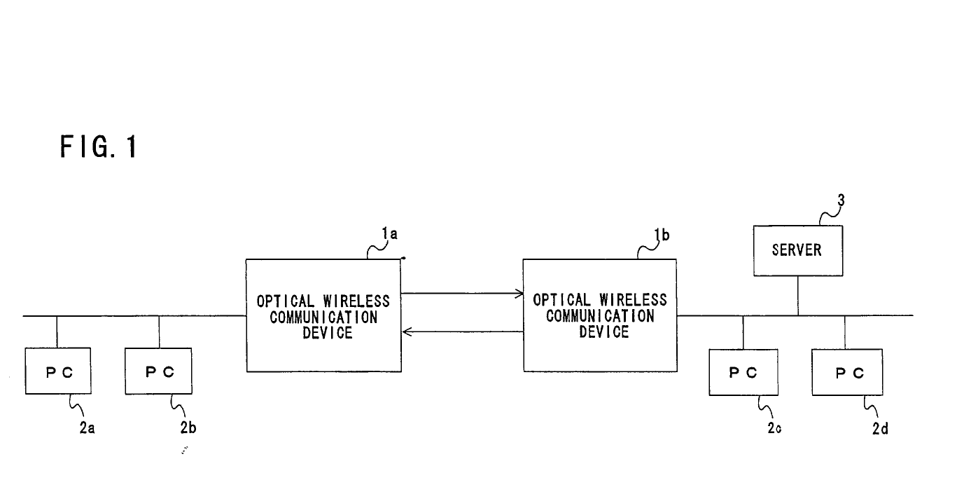

FIG. 1 is a block diagram of a computer network containing an optical wireless communication device according to the present invention. The computer network is LAN (Local Area Network) or WAN (Wide Area Network), for example. In the example here, a computer network is LAN.

The computer network has an optical wireless communication device 1a, 1b, a client computer (a personal computer: PC) 2a, 2b, 2c, 2d, and a server computer 3. In the example here, the optical wireless communication device 1a is connected to the client computer 2a and 2b by a LAN cable. The optical wireless communication device 1b is connected to the client computer 2c, 2d, and the server computer 3 by a LAN cable. The optical wireless communication device 1a and the optical wireless communication device 1b can communicate with each other by optical wireless communication using a laser light.

The optical wireless communication device 1a and 1b whose structures will be detailed later are optical wireless interconnecting devices through which the client computer 2a and 2b, the client computer 2c and 2d, and the server computer 3 communicate with each other.

The client computer 2a, 2b, 2c, and 2d are computers having CPU, ROM, RAM, and so on, and receive service provided by the server computer 3. The server computer 3 is a computer having CPU, ROM, RAM, and so on, and provides service with the client computer 2a, 2b, 2c, and 2d.

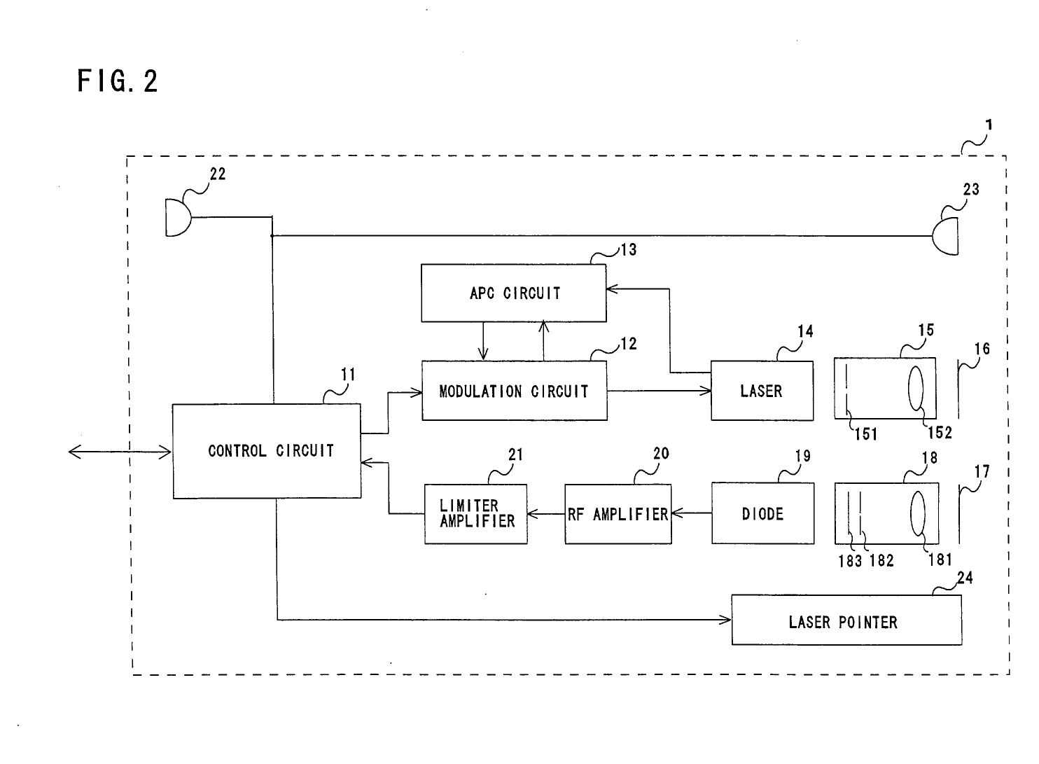

The structure of an optical wireless communication device according to the present invention will now be explained with reference to FIG. 2. The optical wireless communication device 1 according to the present invention has a control circuit 11, a modulation circuit 12, an APC (Automatic Power Control) circuit 13, a laser 14, an outgoing light adjustment unit 15, a light reducing filter 16, a high-pass filter 17, an incident light adjustment unit 18, a diode 19, an RF amplifier 20, a limiter amplifier 21, a LED (Light Emitting Diode) 22, a LED 23, and a laser pointer 24. In FIG. 2, a power circuit and switches are omitted.

The control circuit 11 carries out interface processing for communicating between the optical wireless communication device 1 and the client computer 2 or the server computer 3, and also controls lighting of the LED 22, 23, and the laser pointer 24.

The modulation circuit 12 modulates input signals from the client computer 2 or the server computer 3 to which the interface processing has been carried out by the control circuit 11.

The APC circuit 13 adjusts the intensity of an outgoing light from the laser 14 to a predetermined reference value. For example, the APC circuit 13 measures the intensity of an outgoing light from the laser 14 and compares the measured value with the predetermined reference value. If, as a result of the comparison, the measured value is larger than the reference value, the APC circuit 13 adjusts the modulation circuit 12 so that the intensity of the outgoing light from the laser 14 becomes lower. Conversely, if the measured value is smaller than the reference value, the APC circuit 13 adjusts the modulation circuit 12 so that the intensity of the outgoing light from the laser 14 becomes higher.

The laser 14 emits a laser light based on modulation signals from the modulation circuit 12.

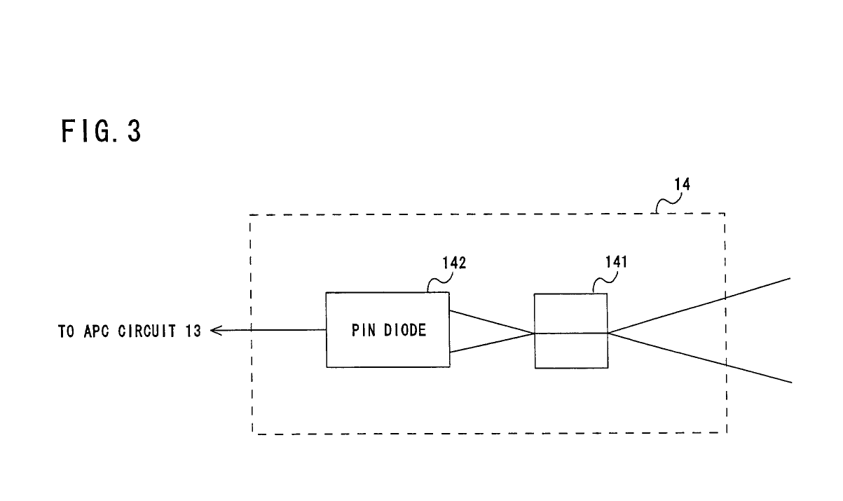

A PIN laser, for example, is used for the laser 14. FIG. 3 shows an example of the structure of the laser 14. The laser 14 shown in FIG. 3 has a PIN laser 141 and a PIN diode 142. The PIN laser 141 emits a laser light forward in the optical wireless communication device 1; at the same time, emits a laser light of the same intensity backward. The PIN diode 142 receives the backward outgoing light and then outputs electric signals corresponding to its intensity to the APC circuit 13. The APC circuit 13 uses the electric signals as a measured value.

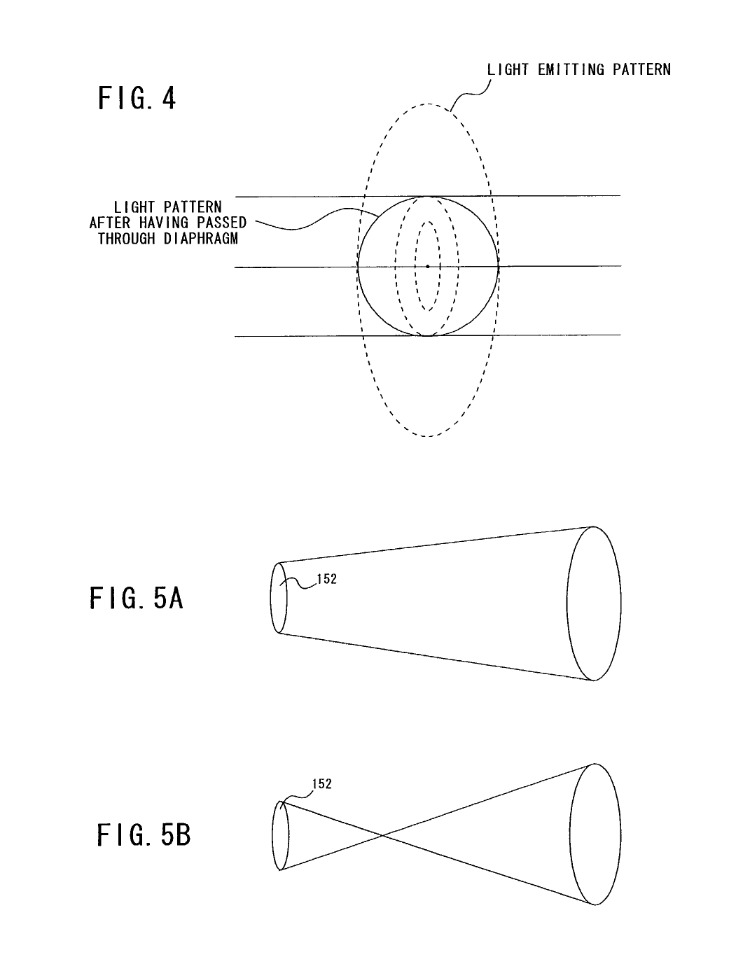

The outgoing light adjustment unit 15 adjusts an outgoing light from the laser 14. The outgoing light adjustment unit 15 is provided with a diaphragm 151 and a lens 152. The diaphragm 151 limits a range of an outgoing light from the laser 14. FIG. 4 shows a light emission pattern of the laser 14 and a light pattern after having passed through the diaphragm 151 in the optical wireless communication device according to the present invention. As shown in FIG. 4, the light emission pattern of the laser 14 is oval with its vertical line longer than its horizontal one when the optical wireless communication device is installed. The light pattern after it has passed through the diaphragm 151 is almost circular, wherein a light pattern of vertical direction is limited when the optical wireless communication device is installed.

The lens 152 refracts an outgoing light from the laser 14 to be almost parallel. In a preferred embodiment of the present invention, the outgoing light is refracted to become wider as going forward as shown in FIG. 5A. For example, a light having a diameter of about 9 mm right after outputted from the optical wireless communication device 1 is refracted to become a light having a diameter of about 300 mm on incidence into the optical wireless communication device 1 of the opposite party. An outgoing light from the optical wireless communication device 1 according to the present invention is not adjusted to take a light path shown in FIG. 5B. It is because that the light shown in FIG. 5B has the problem that a communication condition becomes extremely low when snow or rain is at a crossing point of the lights.

The light reducing filter 16 is a filter to reduce the intensity of lights, and especially when the optical wireless communication device of the other party is located closely, it throttles a laser light by reducing the light intensity to facilitate the handling of the light. The light reducing filter 16, which is removable, is attached to the front of the optical wireless communication device 1. The structure of mounting the light reducing filter 16 will be detailed later. For the light reducing filter 16, it is preferable to prepare several kinds of filters which have different degrees of light reducing to be able to select the one most suitable for use.

The high-pass filter 17, which is attached to the front of the optical wireless communication device 1, is a filter to remove lights of low frequencies including sunbeam to reduce effect of sunbeam and so on. The high-pass filter 17 is, for example, an IR Filter. The high-pass filter 17 is removable as well as the light reducing filter 16. For the high-pass filter 17, it is preferable to prepare several kinds of filters which have different degrees of light reducing to be able to select the one most suitable for use. Also, the high-pass filter can be replaced by the light reducing filter 16. The filters including the light reducing filter 16 and the high-pass filter 17 can be changed in accordance with the environment to match the environmental condition most suitably.

The incident light adjustment unit 18 adjusts incoming lights which have passed through the high-pass filter 17, and specifically, it is provided with a lens 181, a diaphragm 182, and a band pass filter 183.

The diode 19 inputs the incident light which has been adjusted by the incident light adjustment unit 18 to convert the light into electric signals corresponding to its intensity. The diode 19 is, for example, a PIN diode.

The RF amplifier 20 is a circuit to amplify the electric signals outputted by the diode 19.

The limiter amplifier 21 is a circuit to draw stable signals from the electric signals outputted by the RF amplifier 20. The electric signals outputted by the limiter amplifier 21 are inputted to the control circuit 11. The control circuit 11 carries out interface processing to transmit the electric signals outputted by the limiter amplifier 21 to the client computer 2 and the server computer 3.

The LED 22 is an indicator to be mounted on the back of the optical wireless communication device 1 as viewed from the outside. The LED 22 indicates whether or not a laser outputted from the optical wireless communication device 1 of the other party is being received by the optical wireless communication device 1 having the LED 22 in a condition better than a predetermined degree. The LED 22 is installed especially to be checked by those who set a position of or operate the optical wireless communication device 1 having the LED 22. The LED 22 lights up when a laser outputted from the optical wireless communication device 1 of the other party is being received by the optical wireless communication device 1 having the LED 22 in a condition better than a predetermined degree. When not so, on the contrary, the LED 22 doesn't light up.

The LED 23 is an indicator to be mounted on the front of the optical wireless communication device 1 as viewed from the outside. The LED 23 indicates whether or not a laser outputted from the optical wireless communication device 1 of the other party is being received by the optical wireless communication device 1 having the LED 23 in a condition better than a predetermined degree. The LED 23 is installed especially to be checked by those who set a position of or operate the optical wireless communication device 1 of the other party. The LED 23 lights up when a laser outputted from the optical wireless communication device 1 of the other party is being received by the optical wireless communication device 1 having the LED 23 in a condition better than a predetermined degree. When not so, on the contrary, the LED 23 doesn't light up. The LED 23 to be mounted to the optical wireless communication device 1 is not necessarily single as in the example here, but can be two or more. Then, a different LED 23 can lights up according to the intensity of light reception. It is preferable here to use a different color for each LED 23. Further, the LED 23 can be another light emitting element.

The laser pointer 24 emits laser lights according to control of the control circuit 11. The laser pointer 24 is used especially for position adjustment between the optical wireless communication devices 1. The laser pointer 24 is composed of a modulation circuit, an APC circuit, a PIN laser, a diaphragm, a lens, and so on, for example. A laser light emitted by the laser pointer 24 is almost parallel. The laser pointer 24 can emit a highly directional laser light. As shown in the FIG. 11, a sight 401 is mounted in the front of the optical wireless communication device 1, where a laser light emitted from the laser pointer 24 is to strike. Since an optical axis is adjusted by checking if the sight 401 is irradiated, the laser light emitted from the laser pointer 24 should have a luminous flux of the size equal to or smaller than the sight 401 in the front of the optical wireless communication device 1 of the other party located 100 m to 500 m apart. It is necessary for the laser light emitted from the laser pointer 24 to have directivity at least not to fall on a receiving unit 101 when irradiating the sight 401. The light from the laser pointer 24 can thus selectively irradiate the sight 401 which is located beside the receiving unit 101 in the front of the optical wireless communication device 1 of the other party.

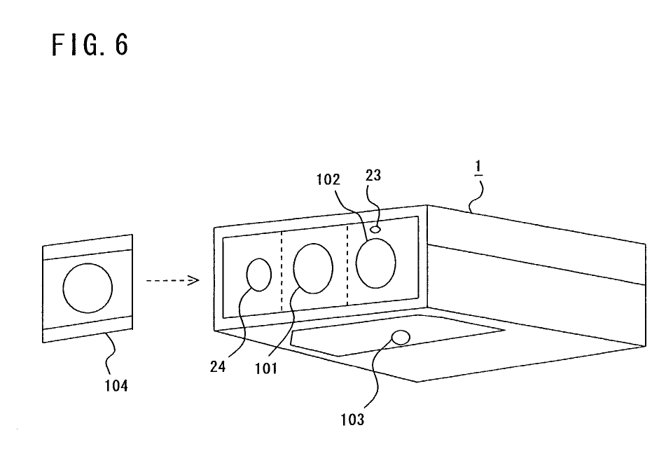

FIG. 6 is a perspective view to especially show the front external appearance of the optical wireless communication device 1 according to the present invention. As shown in the figure, the front of the optical wireless communication device 1 is provided with a laser pointer 24, a receiving unit 101, a transmitting unit 102, and a LED 23. The receiving unit 101 receives a laser light from the optical wireless communication device 1 of the other party by the above mentioned diode 19. The transmitting unit 102 transmits a laser light to the optical wireless communication device 1 of the other party by the above mentioned laser 14.

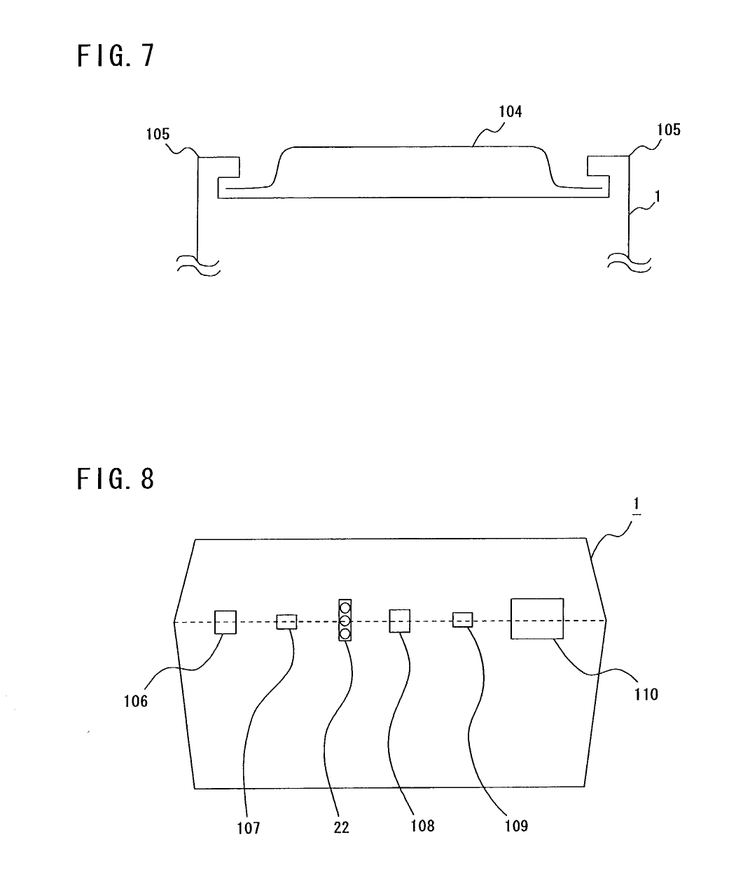

To the transmitting unit 102, a filter holder 104 having the above mentioned light reducing filter 16 or the high-pass filter 17 in its center can be attached. FIG. 7 explains attachment structure of the filter holder 104. The optical wireless communication device 1 is provided with a groove 105 with which both ends of the filter holder 104 can be fitted. The filter holder 104 is made of a flexible material which can be bent by those who handle it. When attached to the groove 105, the filter holder 104 should be once bent so as to fit with the groove 105. The filter holder 104 is made of a material having strength to resist several times use as well as flexibility to be easily attached to as being fitted with the groove. Having the structure explained above, the filter holder 104 can be attached to the front of the optical wireless communication device 1 very easily. It is also possible to fit the filter holder 104 into the groove 105 from the side of the optical wireless communication device 1, sliding it to the position of the transmitting unit 102. The filter holder 104 is not necessarily composed separately of the filter 16 or 17; it can be integral with the filters. In this case, the filter is also made of a flexible material.

FIG. 8 is a rear view of the optical wireless communication device according to the present invention. As shown in the figure, the back of the optical wireless communication device 1 is provided with a DC jack 106, a switch 107 for the laser pointer 24, a LED 22, a changeover switch 108, a linktest switch 109, and a communication terminal 110.

Here, the DC jack 106 is a terminal to supply power with the optical wireless communication device 1. The switch 107 switches over on and off of the laser pointer 24. The changeover switch 108 switches over MID and MIDX. The linktest switch 109 carries out linktest when set to be on. The communication terminal 110, which is RJ-45 for example, is a terminal to communicate with the client computer 2 and the server computer 3 by a cable.

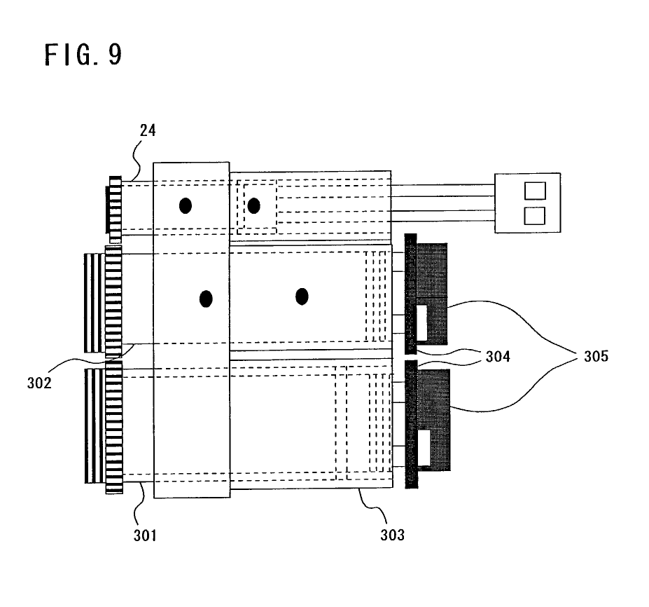

FIG. 9 is a block diagram of a lens holder which is incorporated in the optical wireless communication device 1 according to the present invention. A lens holder 303 is made of synthetic resin, and the laser pointer 24, a transmitting unit 301, and a receiving unit 302 are incorporated to be fixed therein. It is necessary to position the laser pointer 24, the transmitting unit 301, and the receiving unit 302 accurately in relation to each other, and the lens holder 303 permits holding the accurate position of those three. Further, the lens holder 303 is provided with a screw and a silicone ring for fine adjustment of relative positioning of the laser pointer 24, the transmitting unit 301, and the receiving unit 302.

Here, the transmitting unit 301 is a box containing at least the laser 14 and the outgoing light adjustment unit 15. The receiving unit 302 is a box containing at least the incident light adjustment unit 18 and the diode 19. Each of the transmitting unit 301 and the receiving unit 302 is connected to a substrate 304. On the substrate 304 are the modulation circuit 12, the APC circuit 13, the RF amplifier 20, and the limiter amplifier 21. Also, a shielding case 305 is attached to the substrate 304.

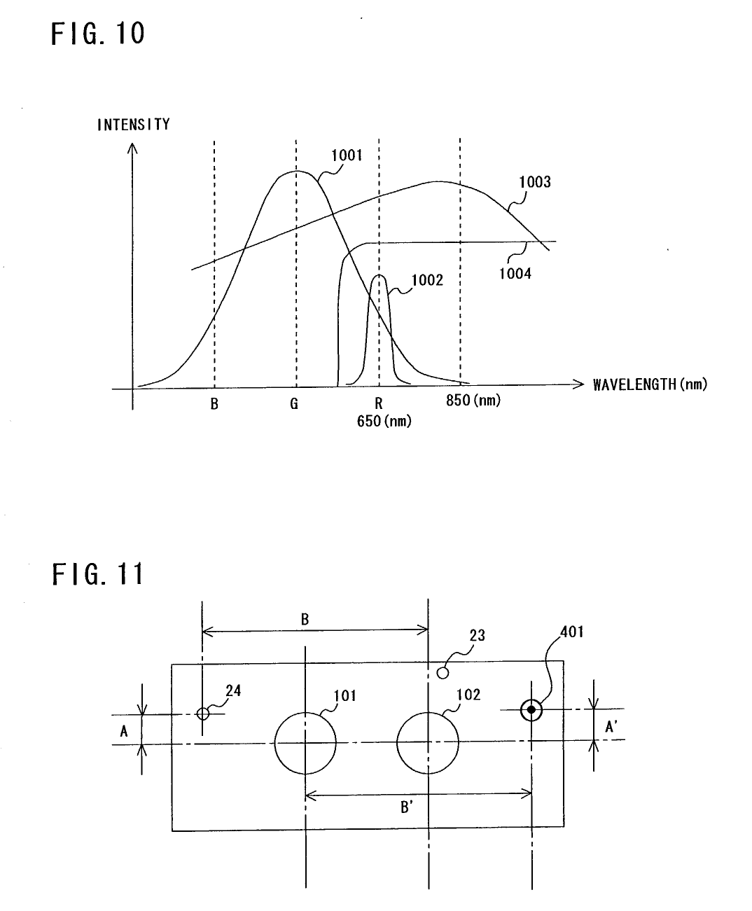

FIG. 10 is a graph to explain a wavelength of a laser light outputted from the optical wireless communication device according to the present invention. In the graph, the horizontal axis indicates wavelength (nm), and the vertical axis intensity. A line 1001 indicates relative luminosity performance. The relative luminosity performance indicates sensitivity of human vision, and its being above a given value means within a visible light region. The relative luminosity performance peaks in a green (G) region, and falls to low in a blue (B) region where the wavelength is shorter and in a red (R) region where the wavelength is greater. Light beams within the visible light region can be perceived by human vision. The range of wavelength in the visible light region is from 380 nm to 400 nm at the shortest to 750 nm to 800 nm at the greatest.

A line 1002 indicates a characteristic of a laser light emitted from the laser 14 in the optical wireless communication device 1 according to the present invention. As shown in the graph, a laser light of around 650 nm is used. As known from the line 1001 indicating the relative luminosity performance, the laser light having a wavelength of 650 nm is a visible light which can be identified by human vision. The laser light does not necessarily have a wavelength of 650 nm as the example here as long as it is within the visible light region to be perceived by those who handle it. It is preferable to use a laser light having a wavelength of between 450 nm and 700 nm.

Since the optical wireless communication device 1 according to the present invention uses the laser emitting a visible laser light as explained above, it has the following effects:

(i) As the laser light outputted from the optical wireless communication device 1 according to the present invention is a visible light, it facilitates determining where the laser light falls on. Therefore, it is easy to arrange the optical wireless communication device 1 in an accurate position.

(ii) Since the laser light outputted from the optical wireless communication device 1 is a visible light, in maintenance of the optical wireless communication device 1, maintenance workers can immediately perceive it if the laser light strikes their eyes, which prevents them from being irradiated for a long time without aware.

(iii) Even if those who are to handle a device outputting a light having a wavelength of more than 700 nm are obligated to receive technical education as provided in the Labor Standards Law in Japan, laser lights outputted from the optical wireless communication device 1 according to the present invention have wavelength of 650 nm, which doesn't require technical education; thus reduces a cost.

In the graph shown in FIG. 10, a line 1003 indicates a receiving performance of the diode 19 in the optical wireless communication device 1 of the receiving side. The receiving performance of the diode 19 generally used in optical wireless communication devices is high for a light having wavelength of around 850 nm, and the farther away is it from the wavelength, the lower becomes the receiving performance. The laser light with a wavelength of 650 nm which is used in the optical wireless communication device 1 according to the present invention is within the region of a wavelength where enough receiving performance is obtained in the diode 19 which is generally used in optical wireless communication devices. Therefore, the laser light with a wavelength of 650 nm practically has no problem in reception as well.

In the graph of FIG. 10, a line 1004 indicates a performance of the high-pass filter 17. The high-pass filter 17 allows a light having a longer wavelength than a certain wavelength of less than 650 nm to pass through, while limiting a light having a wavelength of less than that. Accordingly, the laser light having a wavelength of 650 nm which is used in the optical wireless communication device 1 according to the present invention can pass through the high-pass filter 17.

FIG. 11 is a front view of the optical wireless communication device 1 according to the present invention. As shown in the figure, the sight 401 is mounted in a position where a laser light emitted from the laser pointer 24 is to strike when the two optical wireless communication devices 1 are located opposite to each other, and a laser light outputted from the transmitting unit 102 is being received by the receiving unit 101 of the other party. The sight 401 is mounted in such a position that a relative position of the sight 401 to the transmitting unit 102 becomes equal to a relative position of the laser pointer 24 to the receiving unit 101. Specifically, the horizontal distance A between the transmitting unit 102 and the laser pointer 24 is equal to the horizontal distance A′ between the receiving unit 101 and the sight 401. Also, the vertical distance B between the transmitting unit 102 and the laser pointer 24 is equal to the vertical distance B′ between the receiving unit 101 and the sight 401. Position adjustment of the optical wireless communication devices 1 to each other is easy if adjusting a outgoing light of the laser pointer 24 to fall on the sight 401 of the optical wireless communication device of the other party.

In the following, a position adjustment method for the optical wireless communication device according to the present invention will be explained. As methods of position adjustment for the optical wireless communication device according to the present invention, there are a method using the laser pointer 24 and a method without using the laser pointer 24. For those position adjustment method, the following is a explanation in adjusting a position of a optical wireless communication device 1a relative to a optical wireless communication device 1b, the other party of the communication, by moving a position of the optical wireless communication device 1a. Here, the optical wireless communication device 1a and the optical wireless communication device 1b are generally located 500 m apart, and preferably they are at least 100 apart; normally 300 m to 500 m apart. The position adjustment in the invention here means adjusting a position and direction of optical wireless communication devices.

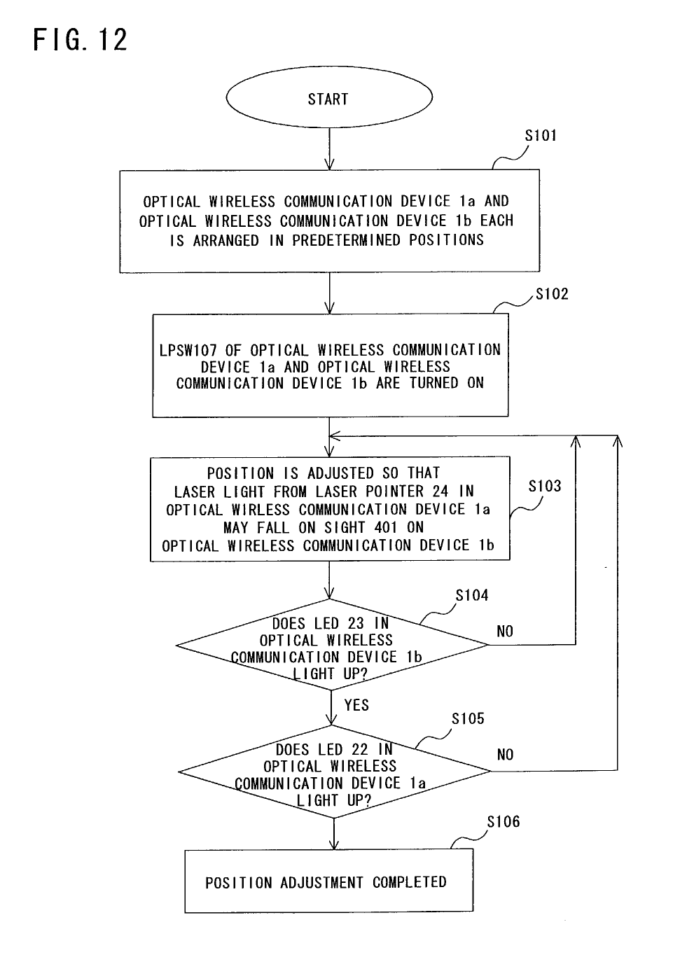

FIG. 12 is a flowchart to show an adjustment method in adjusting a position of the optical wireless communication device using the laser pointer 24. In the first place, the optical wireless communication device 1a and the optical wireless communication device 1b each is arranged in predetermined positions (S101).

In the next place, the power of the entire system of both the optical wireless communication device 1a and the optical wireless communication device 1b is turned on. Further, the laser pointer switch 107 of the optical wireless communication device 1a is switched on (S102). Then, the laser pointer 24 in the optical wireless communication device 1a outputs a laser light to the direction of the optical wireless communication device 1b of the opposite party. A person who handles the device first adjusts a position of the optical wireless communication device 1a so that the laser light emitted from the laser pointer 24 may fall on the front surface of the optical wireless communication device 1b. The position is being adjusted by moving the optical wireless communication device 1a dimensionally up and down or from side to side. Then, he or she adjusts a position of the optical wireless communication device 1a so that the laser light emitted from the laser pointer 24 may fall on the sight 401 mounted on the front of the optical wireless communication device 1b. In this step, an optical axis of the laser pointer 24 and an optical axis of the transmitting unit 102 and the receiving unit 101 are normally aligned; therefore, the laser light outputted from the optical wireless communication device 1a should be received by the optical wireless communication device 1b. Moreover, proper reception of the laser light will be confirmed by the following steps.

When the laser light emitted from the laser 14 in the optical wireless communication device 1a comes into the receiving unit 101 and an optical axis is aligned, the LED 22 and the LED 23 in the optical wireless communication device 1b light up. Checking especially if the LED 23 in the front of the optical wireless communication device 1b lights up (S104), he or she adjusts a position of the optical wireless communication device 1a by moving it up and down or from side to side. In case where the optical wireless communication device 1b is located far away from the optical wireless communication device 1a where a person who handles it is nearby, the LED 23 in the optical wireless communication device 1b can be observed with a telescope. If the LED 23 doesn't light up, he or she adjusts a position again, checking where the laser light from the laser pointer 24 strikes.

When the lighting of the LED 23 in the optical wireless communication device 1b is confirmed, the lighting of the LED 22 in the optical wireless communication device 1a is checked(S105). Upon the confirmation of the lighting of the LED 22 in the optical wireless communication device 1a, adjustment of relative positioning of the optical wireless communication device 1a and the optical wireless communication device 1b is completed (S106).

Incidentally, it is not necessary to check the lighting of the LED 22 in the optical wireless communication device 1a (S105) after confirming the LED 23 in the optical wireless communication device 1b (S104) as in the above example; those steps can be different as the step S104 can come after the step S105, or the both steps can be done at one time.

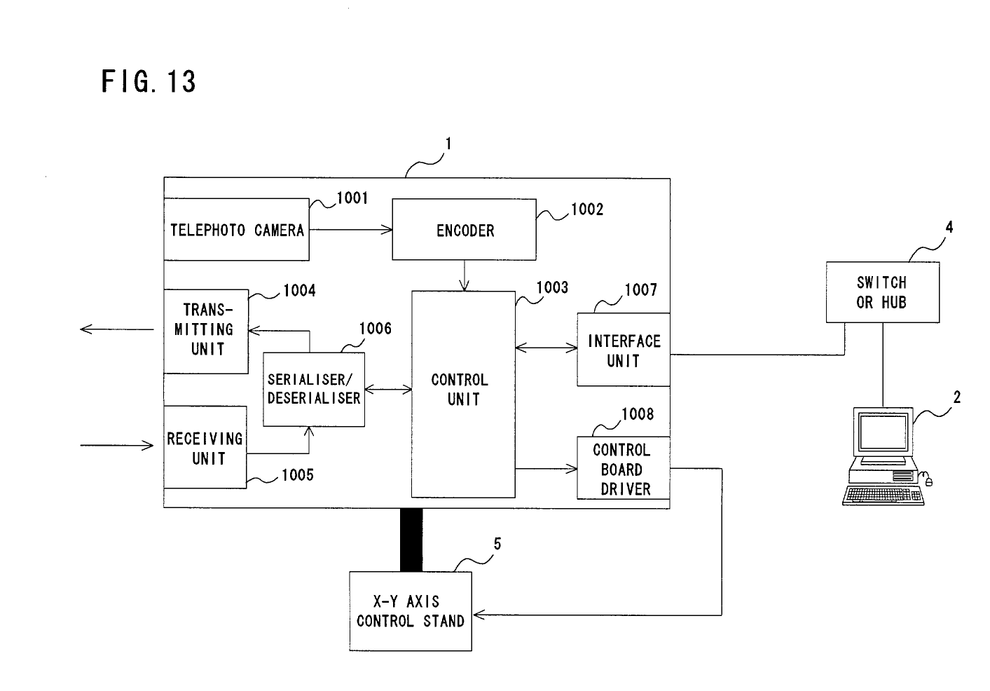

FIG. 13 is a block diagram to show structure of another optical wireless communication device according to the present invention. As shown in the figure, the optical wireless communication device 1 is provided with a telephoto camera 1001, an encoder 1002, a control unit 1003, a transmitting unit 1004, a receiving unit 1005, a serializer/deserializer 1006, an interface unit 1007, and a control board driver 1008. In addition, a X-Y axis control stand 5 is attached to the optical wireless communication device 1. In the example here, the optical wireless communication device 1 is connected to a computer 2 via a switch or hub 4 which is connected to the interface unit 1007 by a LAN cable.

The telephoto camera 1001 is a camera with a telephotographing function to take images of the optical wireless communication device 1 of the opposite party. In the example here, the telephoto camera 1001 is used especially to check the lighting of the LED 23 in the optical wireless communication device 1 of the other party. If a laser light outputted from the optical wireless communication device 1 is a visible light, the telephoto camera 1001 can be used to check where the laser light falls on. Also, if the optical wireless communication device 1 is provided with the laser pointer 24, the telephoto camera 1001 can be used to check where the laser light emitted from the laser pointer 24 falls on.

The encoder 1002 is, for example, an encoder of MPEG 2 or MPEG 4. The encoder 1002 encodes signals outputted from the telephoto camera 1001 to output the result to the control unit 1003.

The control unit 1003 controls the entire system of the optical wireless communication device 1 and also the X-Y axis control stand 5.

The transmitting unit 1004, which is composed of a laser, a lens, an APC circuit, a modulation circuit, and so on, transmits a laser light for optical communication.

The receiving unit 1005, which is composed of a diode, a lens, a filter, and so on, receives a laser light for optical communication.

The serializer/deserializer 1006, which is also called SERDES, converts a stream of serial data into a stream of parallel data and also converts a stream of parallel data into a stream of serial data.

The interface unit 1007 carries out interface processing with external devices such as the switch 4.

The control board driver 1008 drives the X-Y axis control stand on request from the control unit 1003.

The X-Y axis control stand 5, which is connected to the optical wireless communication device 1, adjusts an optical axis by changing a position of the optical wireless communication device 1.

In the computer 2, utility software is installed. The utility software allows a camera image taken by the telephoto camera 1001 in the optical wireless communication device 1 and acquired through the switch 4 to be displayed on a screen of the computer 2. The utility software can also control an image magnification of the telephoto camera 1001. Moreover, the utility software can control performance of the X-Y axis control stand 5.

The following is an explanation for adjusting an optical axis using the optical wireless communication device shown in FIG. 13. First, a person to handle the device operates the computer 2 to take images of the optical wireless communication device of the opposite party with the telephoto camera 1001. In the optical wireless communication device 1, a image data taken by the telephoto camera 1001 is encoded by the encoder 1002 and outputted to the switch 4 through the interface unit 1007. The switch 4 transmits the signals to the computer 2. The computer 2 makes the image appear on the screen in accordance with the signals.

Based on the information displayed on the screen, he or she checks the lighting of the LED 23 in the optical wireless communication device 1 of the opposite party. If a laser light outputted from the optical wireless communication device 1 is a visible light, check a point where the laser light falls on. If the optical wireless communication device 1 is provided with the laser pointer 24, check a point where the laser light emitted from the laser pointer 24 falls on. In case where the screen shows that the LED 23 doesn't light up, he or she should operate the computer 2 to control the X-Y axis control stand 5. Specifically, the X-Y axis control stand 5 is controlled as the control unit 1003 controls the control board driver 1008 and then controls the X-Y axis control stand. In accordance with the control of the X-Y axis control stand 5, the optical wireless communication device 1 moves to adjust an optical axis.

Checking the screen display, a person who is handling the device should repeat the control of the X-Y axis control stand 5 until an optical axis is properly adjusted.

Adjustment of an optical axis is not necessarily carried out by a person who handles the device as checking the screen display of the computer 2 as in the example here. For example, image analyzing means which analyzes images taken by the telephoto camera 1001 can be provided in the optical wireless communication device 1 or an external device for discriminating between on and off of the lighting of the LED 23. It is also feasible to have the image analyzing means check where a laser light from a laser for optical wireless communication falls on or where a laser light from the laser pointer 24 falls on. The optical wireless communication device or an external device is preferably provided further with means for outputting signals for controlling the X-Y axis control stand 5 to align an optical axis into the control unit 1003, based on a result of analysis in the image analyzing means.

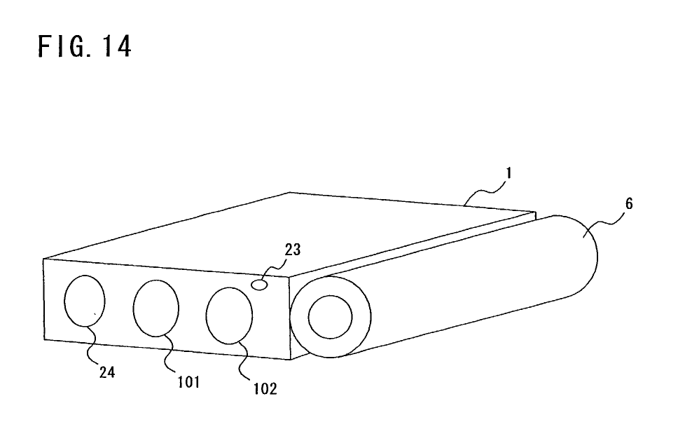

FIG. 14 is a perspective view to show external appearance of another optical wireless communication device according to the present invention. In the example here, a telescope 6 is mounted on the side of the optical wireless communication device 1. The telescope 6 allows to observe a direction almost parallel to an optical axis of the transmitting unit 102. In a preferred embodiment, the telescope 6 is removable from the optical wireless communication device 1. It is also preferable that the telescope 6 has a sight. The sight can be used for position adjustment to align an optical axis.

The laser light emitted from the laser 24 in the optical wireless communication device 1 is not necessarily a laser light within a visible light region as in the above example, but can be a laser light outside of a visible light region. Further, a light outputted from the optical wireless communication device 1 can be other than a laser light, such as an infrared ray.

Output signals from the optical wireless communication device 1 are not necessarily digital signals as in the above example, but can be analog signals as directly outputted. In this case, output signals from the diode 19 can be directly outputted from the optical wireless communication device 1, or they can be outputted after being amplified at an amplifier of each kind.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An optical wireless communication device communicating by light, comprising;
a transmitting unit outputting a light for optical communication; and
an optical axis adjustment light emitting unit which is located at a position other than said transmitting unit, emitting a light for adjusting an optical axis;
wherein the light emitted from said optical axis adjustment light emitting unit selectively irradiates a sight which is located beside a receiving unit receiving a light from said transmitting unit in the front of a optical wireless communication device of the other party.

2. An optical wireless communication device according to claim 1, wherein said optical axis adjustment light emitting unit is a laser pointer.

3. An optical wireless communication device according to claim 1, wherein said transmitting unit and said optical axis adjustment light emitting unit are fixed relative to each other with a holder.

4. An optical wireless communication device according to claim 1, further comprising a telescope with which a direction almost parallel to an optical axis of said transmitting unit can be observed.

5. An optical wireless communication device according to claim 1, further comprising;
a telephoto camera with which a direction almost parallel to an optical axis of said transmitting unit can be observed; and
means for outputting image data taken by the telephoto camera.

6. An optical wireless communication device according to claim 1, further comprising a control unit controlling a position of said optical wireless communication device according to external control signals.

7. An optical wireless communication device according to claim 1, further comprising a light reducing filter in said transmitting unit; wherein said light reducing filter is attachable to and removable from said optical wireless communication device.

8. An optical wireless communication device according to claim 7, further comprising a groove in the front where a laser light is outputted from; wherein a filter holder having said light reducing filter is fitted with said groove.

9. An optical wireless communication device communicating by light, comprising;
a transmitting unit outputting a light for optical communication;
a receiving unit inputting a light for optical communication; and
a removable filter which is attached to said transmitting unit and/or said receiving unit.

10. An optical wireless communication device according to claim 9, further comprising a groove in the front where a laser light is outputted from; wherein a filter holder having said filter is fitted with said groove.

11. An optical wireless communication device according to claim 8 or 10, wherein said filter holder is made of a flexible material.

12. An optical wireless communication device communicating by light, comprising;
a transmitting unit outputting a light for optical communication;
a receiving unit inputting a light for optical communication; and
an indicator indicating reception in the receiving unit of a light from an optical wireless communication device of the other party;
wherein said indicator is mounted on the front surface where a light is outputted from said transmitting unit.

13. An optical wireless communication device according to claim 12, wherein said indicator is constituted of LED.

14. A method of adjusting a position of a first optical wireless communication device and a second optical wireless communication device communicating with each other by lights, comprising;
a step for outputting a light for an optical axis adjustment from said first optical wireless communication device; and
a step for checking if the light outputted from said first optical wireless communication device falls on a sight on said second optical wireless communication device.

15. A method of adjusting a position of a first optical wireless communication device and a second optical wireless communication device communicating with each other by lights, comprising;
a step for outputting a light for optical communication from said first optical wireless communication device; and
a step for checking if the light outputted from said first optical wireless communication device is received by a receiving unit on said second optical wireless communication device by observing an indicator indicating reception of lights, which is mounted on the front of said second optical wireless communication device.
